(19) United States
(12) Patent Application Publication
(10) Pub. No.: US 2010/0163017 A1
(43) Pub. Date: Jul. 1, 2010

(54) STOVES

(75) Inventor: Allan Shepherd, Wynnum West (AU)

Correspondence Address: ABELMAN, FRAYNE & SCHWAB, 666 THIRD AVENUE, 10TH FLOOR, NEW YORK, NY, 10017, US

(73) Assignee: KARALEE INVESTMENTS PTY LTD., Wynnum West, QL (AU)

(21) Appl. No.: 12/663,917

(22) PCT Filed: Jun. 11, 2008
(86) PCT No.: PCT/AU2008/000829

§ 371 Date: Dec. 10, 2009

(30) Foreign Application Priority Data
Jun. 12, 2007 (AU) 2007903785

(51) Int. Cl. A47J 37/07; F24C 15/32; E04F 17/02; B21D 39/03

(52) U.S. Cl. 126/9 R; 126/307 R; 454/1; 29/428

(57) ABSTRACT

A portable stove having combustion chamber for solid fuel, with a fuel inlet and an exhaust outlet; and a chimney stack demountably connected to the exhaust outlet and in fluid communication with the combustion chamber, the chimney stack in its demounted state being wholly stowable within the stove body.

This invention relates to stoves. The invention has particular application to portable stoves but may have application in other areas.

Regulatory authorities in a number of states and countries prohibit open fires using solid fuel (e.g. coal, wood, charcoal etc) in various locations in certain circumstances, for example, drought conditions, high winds or other high fire danger conditions. Such regulations are hard on campers, travelers and tourists who travel in the bush and appreciate the atmosphere created by a solid fuel fire as well as its cooking. Thus there is a need for stoves and similar devices which can be used in the bush without causing significant fire danger. Such stoves and devices would preferably be inexpensive, robust and non-bulky so that they can be readily purchased and easily transported within the bush.

With the foregoing in view, the invention in one aspect resides broadly in a portable stove having a stove body defining at least in part, a combustion chamber for solid fuel, with a fuel inlet and an exhaust outlet and a chimney stack demountably connected to the exhaust outlet and in fluid communication with the combustion chamber, the chimney stack in its demounted state being wholly stowable within the stove body.

Preferably, a cooking opening is provided in an upper portion of the body and is adapted to receive thereover a cooking utensil such as a griddle, wok, kettle, camp oven skewer, spit or the like. In such form, it is preferred that the cooking opening be at least partially surrounded by one or more walls extending upwardly from the body to define a lip adapted to support a wok, saucepan or griddle.

Preferably, the stove body has a substantially cylindrical mid portion or is barrel shaped and wherein the longitudinal axis of the assembled chimney stack fitted to the stove intersects the longitudinal axis of the stove body.

Preferably, the chimney stack in its demounted state includes a plurality of tubular segments wherein each segment has one end portion adapted to receive therein the opposite end portion of one of the other segments to form the chimney stack and wherein each segment is small enough to fit within the combustion chamber.

Preferably, the stove has a plurality of demountable legs, which in their demounted state are so sized and shaped as to fit wholly within the stove body and wherein each leg is adapted to connect to a complementary mount located on the stove body. In such form, it is preferred that the mounts include a screw threaded socket and the legs have complementary screw threaded end portions.

Preferably, the legs are straight and the angle subtended by the longitudinal axis of each leg and a vertical plane between the stove and the ground in the stove's normal attitude of operation when the stove is seen from the front, is different from the angle subtended by the longitudinal axis of the leg and a similar (but orthogonal) vertical plane when the stove is seen from the side.

Preferably, the stove has a griddle pivotally mounted or pivotally mountable to the stove body.

Preferably, a door is pivotally mounted to the stove body adjacent the fuel inlet and adapted to open and close the fuel inlet, the door and stove body being provided with complementary means of engagement to enable the door to be latched.

Preferably, the door has a substantially centrally located aperture surrounded by an integral collar providing a draw for air into the combustion chamber.

Preferably the height of the stove body in its normal attitude of operation is substantially equal to the vertical clearance available between the ground and an exterior base of the stove body when assembled.

Preferably, the stove body is formed at least in part from a gas bottle of the type having a cylindrical mid-portion with opposed torisperical ends welded to opposite ends of the mid portion. In such form, it is preferred that the stove body is formed from a 9 Kg gas bottle of that type by cutting out a mid portion of one torispherical end to form the fuel inlet and cutting out a portion of the cylindrical mid portion to form the cooking opening

In another aspect, the invention resides broadly in a portable stove in the form of a ‘self assembly’ kit, to form a stove as described herein, the kit including:

a stove body;

a plurality of legs mountable to the stove body; and

a plurality of tubular chimney stack segments adapted to connect together to form a chimney stack which is mountable to the stove body.

In such form, it is preferred that the kit further include a poker, a fuel supporting grid, a griddle or a carrying handle or sling or any one or more of these items.

In yet another aspect the invention resides broadly in a method of forming a stove including:

providing a gas bottle having a cylindrical mid-portion with opposed torisperical ends welded to opposite ends of the mid portion;

cutting an opening in the mid-portion of the gas bottle to form a cooking opening;

cutting an exhaust opening in a torispherical end of the gas bottle;

cutting an opening in a torisperical end of the gas bottle to form a fuel inlet; and

pivotally mounting the portion cut away from the torispherical end to form the fuel inlet back onto the gas bottle to form a door adapted to open and close the fuel inlet.

In such form, it is preferred that the method also includes:

connecting an exhaust outlet to the exhaust opening;

connecting a plurality of leg receiving mounts to the gas bottle;

removing the gas bottle's cylindrical base and connecting it to the peripheral wall of the cooking opening to define a lip thereabove; and/or

connecting one or more locating means to the gas. bottle.

In order that the invention may be more readily understood and put into practical effect, reference will now be made to the accompanying drawings wherein:

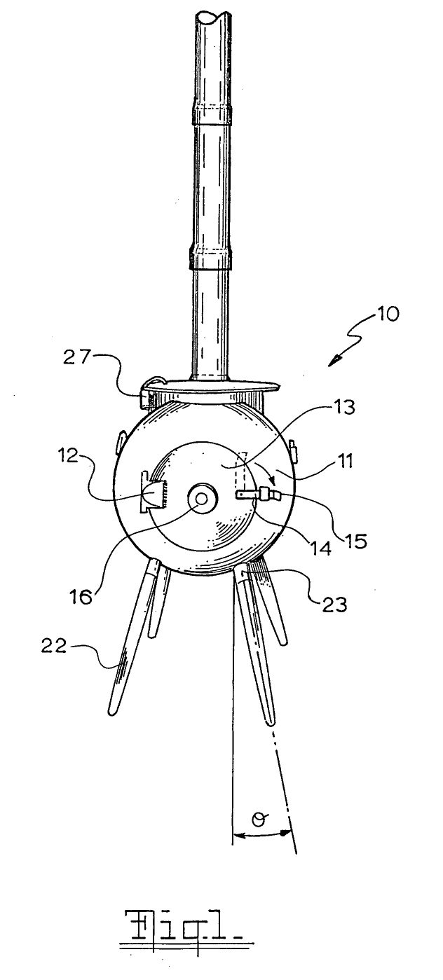

FIG. 1 is a pictorial representation of a stove according to the invention from the front;

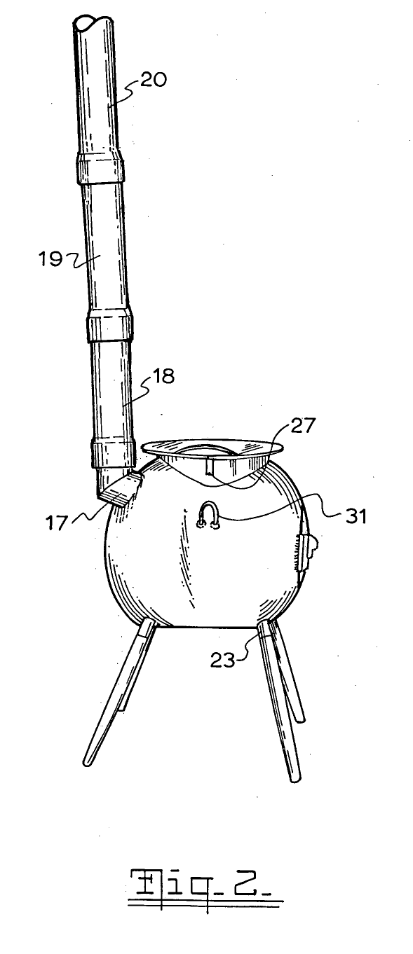

FIG. 2 is a pictorial representation of the stove of FIG. 1 from one side;

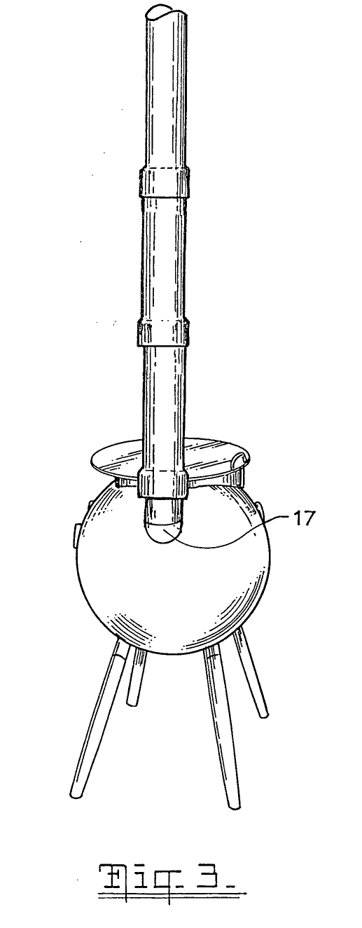

FIG. 3 is a pictorial representation of the stove of FIG. 1 from the rear;

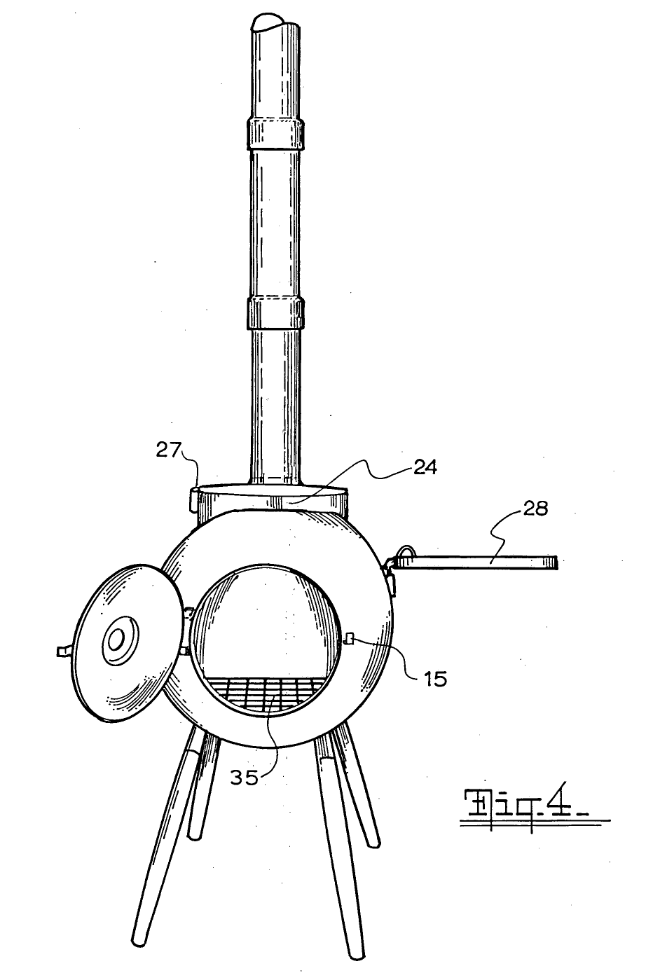

FIG. 4 is a pictorial representation of the stove of FIG. 1 with the griddle mounted at a different location on the stove body to that of FIG. 1 and with the stove door open;

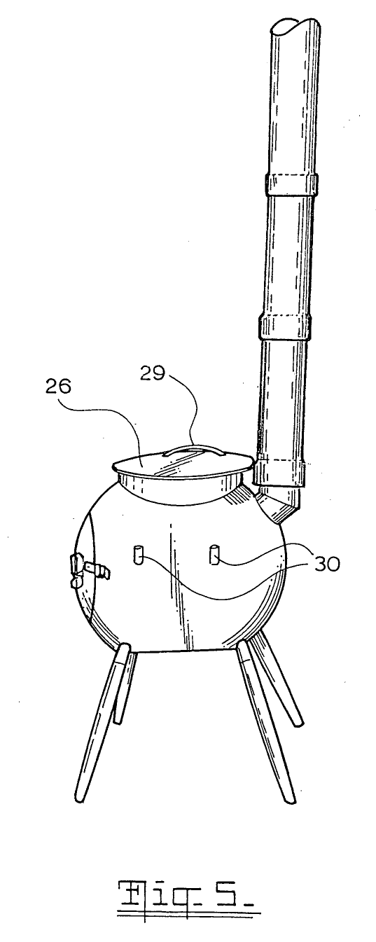

FIG. 5 is a pictorial representation of the stove of FIG. 1 from the other side;

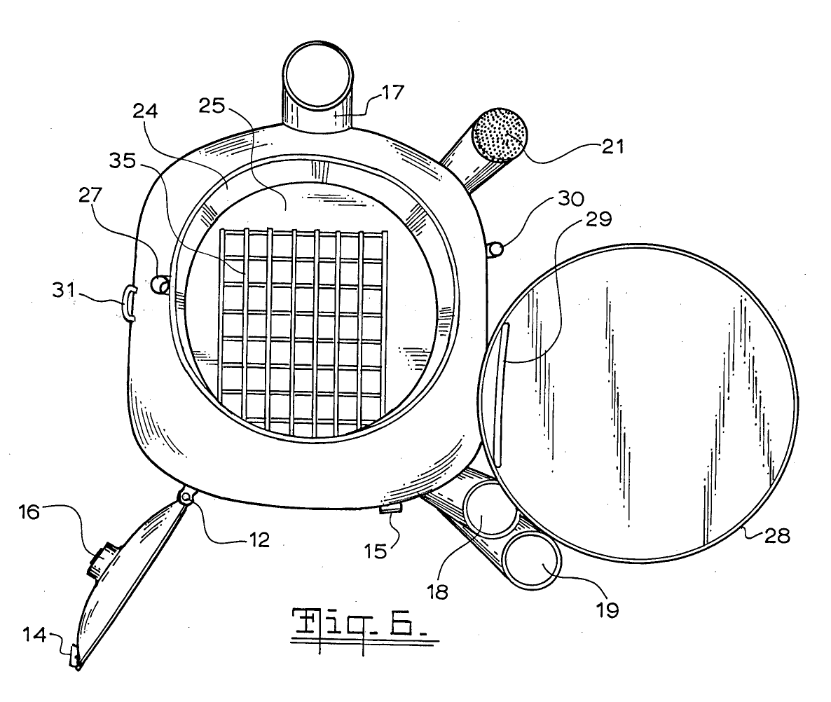

FIG. 6 is a pictorial representation of the stove of FIG. 1 from the top with the chimney stack disassembled and standing adjacent the stove body;

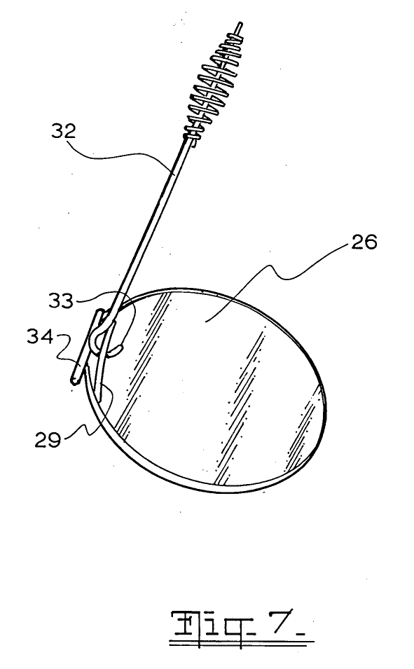

FIG. 7 is a pictorial representation of the poker used to pick up the griddle of FIG. 1.

Advantageously, the stove of the present invention lends itself to a camp atmosphere through scarring and surface damage.

The portable stove 10 is constructed substantially from a 9 kg steel gas bottle and includes an elongate substantially barrel shaped stove body 11 having a cylindrical mid-portion with opposed torisperical ends welded to opposite ends of the mid portion, the stove body defining a combustion chamber. A torrispherical end has had a circular segment concentric with the longitudinal axis cut out of it to form a fuel inlet opening and the segment that was removed to form the fuel inlet has been pivotally mounted 12 back onto the stove body to form a door 13 that is adapted to open and close the fuel inlet.

A rotatable elongate steel latch 14 is pivotally mounted 30 to the door opposite the hinge and engages with a detent 15 welded to the stove body adjacent the fuel inlet opening to latch the door shut. The carrying handle of what once was the gas bottle has been removed revealing the gas bottle's (and now the door mounted) integral screw-threaded open ended collar 16. The collar provides a draw for air into the combustion chamber, whilst the screw thread, coupled with the aperture size and collar length enable the collar to also function as a spark arrestor.

The latch has a substantially 40° fold in it about a line orthogonal to its longitudinal axis such that a portion of the free end of the latch sits away from the stove body.

Within the same vertical plane as the longitudinal axis of the stove body but located above the axis and to the rear of the stove body, a circular piece of the barrel has been removed to from an exhaust opening that is surrounded by a chimney stack connector fitting welded to the stove body to form an exhaust outlet 17.

The free end of the exhaust outlet in the assembled stove's normal attitude of operation is substantially vertical and is adapted to receive a tubular segment of an elongate chimney stack for fluid communication with the combustion chamber. The stack is formed from three similar segments in the form of elongate straight circular steel tubes 18,19,20 originally stowed in the combustion chamber. Each segment has an end portion concentric with but greater in diameter than the rest of the segment enabling it to slidingly engage with an opposing end of another segment. In this way the stack is formed and the remaining free end portion of the stack slides over the exhaust outlet. The longitudinal axis of the assembled stack intersects the longitudinal axis of the stove body at an angle of substantially 90 degrees. The uppermost tube 20 is provided with an integral spark arrestor 21.

The stove body's lower curved periphery in use forms a base portion and the upper curved periphery forms a top portion. The stove has four identical steel legs 22, provided with a screw threaded portion at one end to enable each leg to be screw threaded into complementary steel screw threaded sockets 23, welded onto the base portion of the stove body, the exterior surface of each leg being substantially flush with the exterior surface of each socket.

Once the legs have been connected to the stove body and the stove body placed on the ground, the height of the stove body is substantially equal to the vertical clearance between the ground and the lowermost part of the base portion.

The angle θ subtended by a vertical plane from the weld linking the socket to the stove body and the longitudinal axis of the socket when both are viewed from the front of the stove (FIG. 1) is substantially 20°, whereas the angle a subtended by a vertical plane from the weld linking the socket to the stove body and the longitudinal axis of the socket when both are viewed from the side of the stove (FIG. 2) is substantially 8°.

The annular base of what was the gas bottle has been removed and the annulus 24 formed welded to the top portion to completely surround a circular aperture (substantially identical in size to the annulus) cut into the top portion to form a cooking opening 25. The annulus acts as a raised lip to support a circular griddle 26. Welded onto the exterior surface of one side of the lip of the annulus is an elongate steel tube 27, with a substantially vertical longitudinal axis. The griddle has a flat base and a downwardly depending locating pin located towards its periphery that locates within the steel tube 27, enabling the griddle to freely rotate about the pin. The flat top of the griddle has a continuous raised peripheral lip 28 and an arcuate handle 29, both ends of the handle being welded to the top surface of the griddle adjacent the peripheral lip. Similar pin locating tubes 30 are welded elsewhere on the stove body.

The cooking opening is larger in diameter than the fuel inlet however, both are large enough to receive the tubular sections of the chimney stack or each of the legs. In addition, an eye 31 that comprises a steel “n” clip is welded to the stove body. A poker 32 is provided that has a hook 33 and bar 34 at one end, the latter designed to act as a fulcrum when the hook passes through and is connected to the arcuate handle of the griddle and can be used as a lever to lift the griddle from the annulus and relocate the griddle (via the pin and the available tubes) elsewhere on the stove to act as a shelf to support for example a kettle. A flat square apertured grid 35 is also provided which acts as a support for solid fuel when placed within the combustion chamber. The grid resting on the curved inner surface of the combustion chamber provides an air gap below the grid to assist combustion of the fuel. The stove body is sized and shaped as to be stowable within a ruck sack.

In use, the stove body is first emptied of the grid, poker, four legs, griddle and three stove chimney components.

Each of the legs is then screwed into a respective socket and the chimney stack assembled and mounted to the exhaust outlet. The grid is then placed in the combustion chamber and solid fuel placed on top of the grid either via the fuel inlet or the cooking opening. The griddle is then fitted to the annulus via the pin/tube connection and the fuel lit. With the door latched shut and the griddle swung over the cooking opening, the griddle is ready for use. Air is drawn through the stove body via the collar exiting via the stove chimney stack.

The foregoing description has been given by way of illustrative example of the invention and many modifications in variations which will be apparent to persons skilled in the art may be made without departing from the spirit and scope of the invention as defined in the appended claims.

1-17. (canceled)

18. A portable camping stove including:
a stove body having a cylindrical mid-portion with a longitudinal axis and opposed torisperical end portions welded to opposite ends of the mid-portion and co-axial therewith to define a combustion chamber for wood;
support means demountably connected to said stove body for supporting said stove body in an elevated in-use position with the longitudinal axis of said cylindrical mid-portion substantially horizontal;
a feed inlet in one of said end portions for feeding wood to said combustion chamber and an exhaust outlet for exhausting smoke from said combustion chamber; and
an upward facing cooking opening in said mid-portion for heat transfer to a cooking griddle, wok, kettle, camp oven skewer or saucepan therethrough.

19. A portable camping stove according to claim 18 including a chimney stack demountably connected to said exhaust outlet and in fluid communication with said combustion chamber, said chimney stack in its demounted state being wholly stowable within the stove body.

20. A portable camping stove according to claim 19 wherein said cooking opening is at least partially surrounded by a wall extending upwardly from the cylindrical mid-portion and terminating in an edge or lip adapted to support a griddle, wok, kettle, or saucepan thereon.

21. A portable camping stove according to claim 19 wherein the longitudinal axis of the assembled chimney stack is coplanar with the longitudinal axis of the stove body.

22. A portable camping stove according to claim 19 wherein the chimney stack includes a plurality of tubular segments, adapted to fit together end to end with each other and all segments are adapted to be stowed in said combustion chamber.

23. A portable camping stove according to claim 22 wherein said support means includes a plurality of demountable legs which in their demounted state are adapted to be stowed in said combustion chamber.

24. A portable camping stove according to claim 23 wherein said demountable legs are straight and diverge downwards away from the stove body in the direction of the longitudinal axis and in the direction lateral to the longitudinal axis.

25. A portable camping stove according to claim 18 wherein said stove body includes mounting means for pivotally mounting a griddle thereto.

26. A portable camping stove according to claim 18 including a door pivotally mounted to said one end portion adjacent said feed opening.

27. A portable camping stove according to claim 26 wherein said door has a draw aperture therein surrounded by a collar.

28. A portable camping stove according to claim 18 formed from a gas bottle of the type having a cylindrical mid-portion with opposed torisperical end portions welded to opposite ends of the mid portion.

29. A method of forming a portable camping stove including:
providing a gas bottle having a cylindrical mid-portion with opposed torisperical end portions welded to opposite ends of the mid portion;
cutting an opening in said mid-portion to form a cooking opening;
cutting an opening in one of said torisperical end portions to form an exhaust outlet;
cutting a centre piece from the other one of said torisperical end portions to form a feed inlet opening; and
pivotally mounting the centre piece to the torisperical end portion adjacent said feed opening to form a door adapted to open and close the feed opening.

30. A method according to claim 29 including:
connecting a chimney stack to said exhaust opening; and
connecting a plurality of leg receiving mounts to said gas bottle opposite said cooking opening.

31. A method according to claim 30 wherein the gas bottle provided also includes a cylindrical base portion connected to one of said torisperical end portions, including:
removing said cylindrical base portion and welding said removed base portion to said mid-portion about said cooking opening to define a lip thereabove adapted to support a griddle, wok, kettle, camp oven skewer or saucepan thereon.

32. A method according to claim 31 including welding a piece of tube to said mid-portion adjacent said cooking opening such that its longitudinal axis is vertical when in the elevated in-use cooking position for pivotally mounting a cooking plate thereto.

33. A portable camping stove including:
a stove body having a cylindrical mid-portion with a longitudinal axis and opposed rounded end portions welded to opposite ends of the mid-portion and co-axial therewith to define a combustion chamber for wood;
support means demountably connected to said stove body for supporting said stove body in an elevated in-use position with the longitudinal axis of said cylindrical mid-portion substantially horizontal;
a feed inlet in one of said end portions for feeding wood to said combustion chamber and an exhaust outlet for exhausting smoke from said combustion chamber; and
an upward facing cooking opening in said mid-portion for heat transfer to a cooking griddle, wok, kettle, camp oven skewer or saucepan therethrough.
